(19) United States
(12) Patent Application Publication
(10) Pub. No.: US 2009/0156206 A1
(43) Pub. Date: Jun. 18, 2009

(54) Frequency Band Selection Methods and Apparatus

(75) Inventors: Bela Rathonyi, Lomma (SE); Ali G. Nader, Malmo (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/958,929

(22) Filed: Dec. 18, 2007

(51) Int. Cl. H04Q 7/20; H04M 1/00

(52) U.S. Cl. 455/434; 455/550.1

(57) ABSTRACT

To avoid problems caused by conventional cell search algorithms, a user equipment in a mobile communication system uses knowledge of its previous geographical position and travel times together with stored information on frequency band allocations to determine the frequency band(s) it should search when it is in an out-of-service state, which can result from loss of radio coverage or from power-off.

### BACKGROUND

This invention relates to electronic communication systems and more particularly to wireless communication systems.

Since the introduction of wireless telecommunication systems, the number of mobile users has grown, and is expected to continue growing substantially, especially with mass-market uptake of mobile triple play (a combination of mobile telephony, mobile broadband, and mobile television (TV). That increase together with increasing user demand for higher data rates has created a need for additional frequency bands and user equipment, such as mobile phones and other remote terminals, that supports multiple frequency bands. Of course, the allocation of frequencies for cellular telecommunication networks in the world is complex and is growing more so.

Mobile communication systems include time-division multiple access (TDMA) systems, such as cellular radio telephone systems that comply with the GSM telecommunication standard and its enhancements like GSM/EDGE, and code-division multiple access (CDMA) systems, such as cellular radio telephone systems that comply with the IS-95, cdma2000, and wideband CDMA (WCDMA) telecommunication standards. Digital communication systems also include “blended” TDMA and CDMA systems, such as the universal mobile telecommunications system (UMTS), which is a third generation (3G) mobile system being developed by the European Telecommunications Standards Institute within the International Telecommunication Union's IMT-2000 framework. The Third Generation Partnership Project (3GPP) promulgates specifications for the UMTS and WCDMA systems.

3G mobile communication systems based on WCDMA as the radio access technology (RAT) are being deployed all over the world. High-speed downlink packet access (HSDPA) is an evolution of WCDMA that provides higher bit rates by using higher order modulation, multiple spreading codes, and downlink-channel feedback information. Another evolution of WCDMA is Enhanced Uplink (EUL), or High-Speed Uplink Packet Access (HSUPA), that enables high-rate packet data to be sent in the reverse, or uplink, direction. New RATs are being considered for evolved-3G and fourth generation (4G) communication systems, although the structure of and functions carried out in such systems will generally be similar to those of earlier systems.

WCDMA communication systems currently operate in frequency bands around 850 megahertz (MHz), 1700 MHz (in Japan and the U.S.), 1800 MHz, and 2100 MHz (in the U.S.). To enhance capacity and coverage potential in the future, WCDMA systems are expanding to frequency bands around 900 MHz and 2500 MHz. FIG. 1 is a plot of band identification number (on the vertical axis) against frequency (on the horizontal axis) for several WCDMA frequency bands. Details of this arrangement are described in, for example, Section 5 of 3GPP Technical Specification (TS) 25.101 V7.7.0, User Equipment (UE) Radio Transmission and Reception (FDD) (Release 7) March 2007.

As a result, a UE supporting several frequency bands has to cope with the problem of searching for cells/services in the correct frequency band, which depends on the geographical area that the UE is in. A cell belongs to a public land mobile network (PLMN), and cell/PLMN selection has a number of objectives, which include connecting a UE to the cell(s)/PLMN(s) that will provide the highest quality of service (QoS), enable the UE to consume the least power, and/or generate the least interference. Cell/PLMN selection is usually based on the signal strength (signal to interference ratio (SIR) or signal to noise ratio (SNR)) of candidate cells. For 3GPP-compliant mobile communication systems, the PLMN selection process is specified in Section 4.4 of 3GPP Technical Specification (TS) 23.122, Non-Access-Stratum (NAS) functions related to Mobile Station (MS) in idle mode (Release 7), V7.5.0 (June 2006).

When a UE, such as a mobile telephone or other remote terminal is powered on, the UE typically first looks for a signal from the cell on which the UE previously was camped, and if that cell is not found, the UE searches for other cells in the frequency band of the cell on which the UE previously was camped. If such a search proves fruitless, the typical UE starts an “initial cell search” procedure that involves scanning all carrier frequencies in the frequency band(s) that the UE believes is or are available in order to find an acceptable cell of a PLMN. On each of the carrier frequencies, the UE searches at least for the strongest cell.

Although every UE implements some kind of search algorithm that controls when, how often, etc. the different frequency bands supported by the UE are searched, it is not obvious how the UE should search those frequency bands. This search problem also arises when the UE loses coverage and cannot find a cell in the previously camped-on frequency band. Search algorithms that are typically used today result in searches through all frequency bands supported by a UE in increasing, decreasing, or random order of frequency.

For an example of the current typical operation, assume that a UE capable of handling the WCDMA 2100 MHz frequency band (i.e., Band I in FIG. 1) is turned off in a geographical area (e.g., a country such as Sweden) where the 2100 MHz band actually is used for WCDMA. Assume also that the UE was camped on a cell and service was available before the UE was powered off. When the UE is powered on again, the UE typically assumes that it has not moved geographically and hence it tries to find the last cell or another cell in the 2100 MHz band. If the UE has moved or for some other reason cannot find a cell in the 2100 MHz band, the UE proceeds to scan the 2100 MHz band, measuring its received power on each possible carrier frequency in the band.

The scan procedure, which may be called a received signal strength indicator (RSSI) scan, results in measurements within the relevant channel bandwidth (e.g., 5 MHz) on roughly 300 possible carriers in the 2100 MHz band. It can take about 300 milliseconds (ms) for a UE to scan 300 carrier frequencies in the 2100 MHz band. FIG. 2 shows an example of a result of an RSSI scan as a plot of received energy versus frequency, showing energy peaks measured by a UE in the 2100 MHz band.

The typical UE deeply explores (i.e., performs cell search on) each of the frequencies having more than a threshold energy, usually starting around the highest-energy frequencies and working through the rest of the frequencies until a cell is found to camp on. Cell search is a time- and energy-consuming procedure for a UE; for example, each cell search may take up to 400 ms.

To illustrate some of the problems with existing cell search approaches, assume that a UE supports Bands I, III, and V depicted in FIG. 1, that the UE was camped on a cell in Band I just prior to its being powered off, and that the UE has been moved to a geographical area where Band III is used for WCDMA. With a conventional cell search algorithm, the UE assumes when it is powered on that it is still in the same geographic area. After unsuccessfully searching for a cell on the last-camped-on frequency, the UE performs an RSSI scan in the downlink part of Band I and then conducts a futile search for cells in Band I before it eventually understands that there are no cells available in this band. Much energy and time is wasted on the search for non-existent Band I cells, and even if the UE eventually determines that Band I is not the correct band, the UE does not know which of its other supported bands (Band III and Band V in this example) is correct. Thus, the UE could perform another futile search.

As another example, assume that a UE operating in Band I suddenly finds itself in a radio shadow (e.g., the UE is taken into a basement or is driven into a tunnel), resulting in loss of service. After a long-enough period in the radio shadow, the UE runs an RSSI scan of Band I and determines that no cells are available. The UE may then search the other two bands it supports (Bands III and V in this example), wasting energy and time. If during the time that the UE is searching for cells in the other two bands the radio environment improves (e.g., the UE leaves the basement or tunnel), the UE may not notice as it is busy with the other bands and give the user no service until the UE finds service again in Band I. Of course, such operation is not well received by the user.

Searching in an incorrect frequency band wastes a substantial amount of electric power, which is a concern for a battery-powered UE, and subjects the user to a substantial amount of time without service. A UE may even falsely believe that energy received from other sources is received from candidate cells (radio base stations (RBSs)), and hence be tricked into searching for cells in vain. This is especially likely in cases where frequency bands overlap each other (see, e.g., Bands I and II around 1900 MHz in FIG. 1). Hence, it is very important for a multi-band UE to use intelligent searching strategies.

U.S. Pat. No. 6,223,042 to Raffel describes identifying a preferable wireless service provider using a frequency band search schedule based on information gathered by the wireless network. The information may be related to prior registrations of a wireless device and be used to predict a likely location of the device when it is next powered up. Using the likely location, the search schedule may be designed and used during the next power-up. The search schedule may be changed dynamically to reflect changes in the location of the device or in prior usage history.

U.S. Patent Application Publication No. US 2004/0116132 by Hunzinger et al. states that it describes a mobile unit that determines its geographic position, and based on that position, searches for a desirable wireless communication system among multiple wireless communication systems. The geographic position may be determined by a global positioning system or estimated by dead reckoning from a last-known position.

U.S. Patent Application Publication No. US 2006/0009219 by Jaakkola et al. describes determining the location of a switched-on mobile terminal using a cellular communication system's mobile country code (MCC) or global positioning system (GPS) information, and based on that location, determining the transmission channels and power levels to be used by the terminal in another communication system, such as a wireless local area network (WLAN). Location information can be cached for a time for situations where the mobile terminal is switched off. The length of caching time is modifiable based on the amount of time it would take the terminal to travel from one location to another. For example, five hours may be a preferable time period since one currently cannot travel to the U.S. from Europe in a shorter period of time.

U.S. patent application Ser. No. 11/615,162 by Joachim Ramkull et al. for “Efficient PLMN Search Order” describes how a UE can shorten the time needed to find a cell, such as a suitable or acceptable cell, by using intelligent search orders.

The amount of time that a UE is without service can be unnecessarily long and the UE's power consumption can be unnecessarily high due to futile searches in frequency bands that it supports. Improved solutions are needed to those problems.

### SUMMARY

In accordance with aspects of this invention, there is provided a method of determining a frequency band in which to search for a cell in a communication system having plural cells. The method includes the steps of checking for a cell at a frequency in a frequency band, the frequency being a frequency on which the UE previously had service from the communication system; and if a cell is not found at the frequency, carrying out the steps of determining a current location indicator, and determining at least one frequency band in which to search for a cell based on the current location indicator.

The step of determining the current location indicator comprises determining a current location based on signals transmitted in a global positioning system, or retrieving a stored time indicator that indicates a time at which the UE previously had service and a stored location indicator that indicates a location of the UE at the time at which the UE previously had service, determining an elapsed time since the time at which the UE previously had service, and determining at least one possible location based on the elapsed time and a set of shortest flying times from the location of the UE at the time at which the UE previously had service.

In accordance with further aspects of this invention, there is provided an apparatus in a UE for determining a frequency band in which to search for a cell in a communication system having plural cells. The apparatus includes a device configured to check for a cell at a frequency in a frequency band, the frequency being a frequency on which the UE previously had service from the communication system; and a processor configured, if a cell is not found at the frequency, to determine a current location indicator either by determining a current location based on signals transmitted in a global positioning system or by retrieving a stored time indicator that indicates a time at which the UE previously had service and a stored location indicator that indicates a location of the UE at the time at which the UE previously had service, determining a current location indicator based on an elapsed time since the time at which the UE previously had service and at least one possible location based on the elapsed time and a set of shortest flying times from the location of the UE at the time at which the UE previously had service; and to determine at least one frequency band in which to search for a cell based on the current location indicator

In accordance with further aspects of this invention, there is provided a computer-readable medium having stored instructions that, when executed by a computer, cause the computer to perform a method of determining a frequency band in which to search for a cell in a communication system having plural cells. The method is carried out in a UE in the communication system and includes the steps of checking for a cell at a frequency in a frequency band, the frequency being a frequency on which the UE previously had service from the communication system; and if a cell is not found at the frequency, carrying out the steps of determining a current location indicator, and determining at least one frequency band in which to search for a cell based on the current location indicator. The step of determining a current location indicator includes either determining a current location based on signals transmitted in a global positioning system, or retrieving a stored time indicator that indicates a time at which the UE previously had service and a stored location indicator that indicates a location of the UE at the time at which the UE previously had service, determining an elapsed time since the time at which the UE previously had service, and determining at least one possible location based on the elapsed time and a set of shortest flying times from the location of the UE at the time at which the UE previously had service.

### BRIEF DESCRIPTION OF THE DRAWINGS

The various objects, features, and advantages of this invention will be understood by reading this description in conjunction with the drawings, in which:

FIG. 1 depicts frequency bands for communication systems;

FIG. 2 is an example of a result of a received-energy scan in a 2100 MHz frequency band;

FIG. 3 is a flow chart of a method of searching for a frequency band;

FIG. 4 is a block diagram of a user equipment in a communication system; and

FIG. 5 is a block diagram of a communication system.

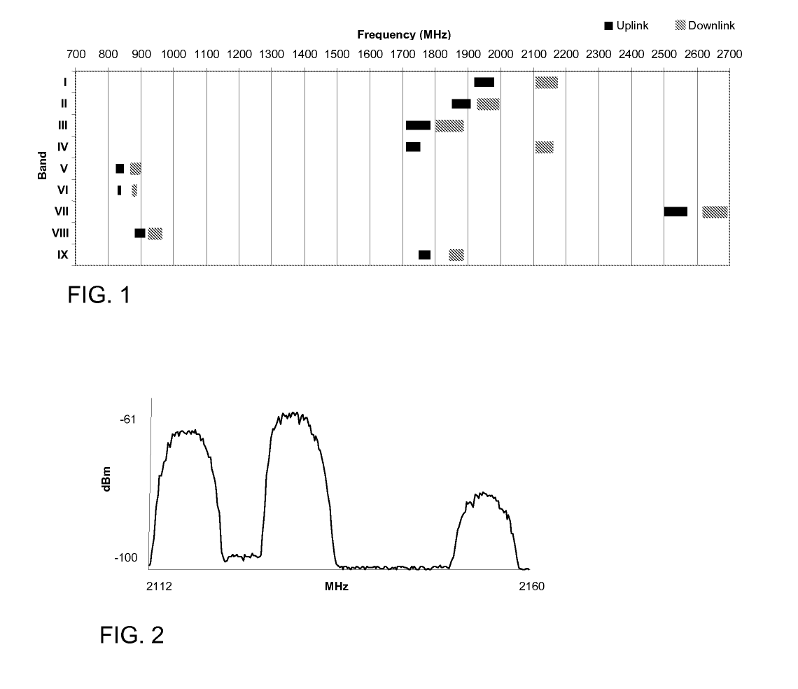

### DETAILED DESCRIPTION

This application focuses on WCDMA communication systems for economy of explanation, but it will be understood that the principles described in this application can be implemented in other communication systems.

To avoid the problems caused by conventional search algorithms, the inventors have recognized that the UE should use knowledge of its geographical position together with stored information on frequency band allocations and travel times to determine the frequency band(s) it should search when it is in an out-of-service state, which can result from loss of radio coverage or from power-off.

The geographical position can be either the UE's current position, which can be determined in any suitable way when an out-of-service condition is detected, or a stored last-known position that was determined some time before the out-of-service condition was detected. For example, the UE's position can be either exact coordinates, e.g., longitude and latitude, which can be obtained from a UE device, such as a GPS receiver, or a coarser position estimate, e.g., a country, which can be obtained from the MCC or an MCC-like parameter broadcast by the cell on which the terminal previously was camped. The MCC is a broadcast parameter of all GSM and WCDMA communication systems. The stored information on frequency band allocations can include geographical areas for different frequency bands and possibly information on travel times between geographical areas. When the UE's current position is not available, the travel-time information can be used with the last-known position and with the time elapsed since the out-of-service state was detected to determine one or more frequency bands in which to perform cell search.

Thus, the UE uses knowledge of its position and a stored database of frequency-band allocations in the world as inputs to a method for determining a frequency band or bands to be searched after going out-of-service and at power-on. The position information may have been obtained some time before the UE goes out-of-service. In that case, the time elapsed since the UE went out of service can be used with another database holding information on travel times between the frequency-band allocation areas to determine one or more possible current positions of the UE. The frequency-band allocations for such possible current positions can be then obtained and searched when the UE tries to return from an out-of-service state.

Table 1 is an example of information in a frequency-band-allocation database. In the table, geographic coordinates are not explicitly indicated, but such coordinates would typically include sets of ranges of latitudes and longitudes or equivalent information. In the MCC entries in the table, asterisks indicate wild-card characters. It will be understood that Table 1 is just an example and that other sets and arrangements of information can be used. The frequency-band-allocation database is called a “frequency allocation list” in this application.

TABLE 1

| | | | GSM | WCDMA |
|---|---|---|---|---|
| | GPS | | freq | freq |
| Area | Coordinates | Area MCCs | bands | bands |
| Europe | { . . . } | 2** | 900/1800 | 2100 |
| | | (e.g., | | |
| | | Sweden = 240 | | |
| North America | { . . . } | 3** | 850/1900 | 800, |
| | | (e.g., | | 1900 |
| | | USA = 310) | | |
| South | { . . . } | 724 (Brazil), 734 | 900/1800 | — |
| America 1 | | (Venezuela) | | |
| South | { . . . } | 7** (rest of | 850/1900 | — |
| America 2 | | South America) | | |
| Japan | { . . . } | 440 | — | 850, |
| | | | | 2100 |
| Africa | { . . . } | 6** | 900/1800 | — |
| Asia/Oceania 1 | { . . . } | 4xx, 4yy, | 900/1800 | 2100 |
| | | 4zz, . . . , 5ii, 5jj, | | |
| | | 5kk, . . . | | |
| South Korea | { . . . } | 450 | — | 2100 |
| Asia/Oceania 2 | { . . . } | 4**, 5** (rest of | 900/1800 | — |
| | | Asia/Oceania) | | |
| Australia | { . . . } | 505 | 900/1800 | 850, |
| | | | | 2100 |

Table 2 is an example of the information in a travel-time database, called a “flight time matrix” in this application, that holds information on the shortest or substantially the shortest commercial flying times (e.g., in hours) between areas in the frequency allocation list. It will be understood that Table 2 is just an example (e.g., only flying times in hours from Europe are shown) and that other sets and arrangements of information can be used.

TABLE 2

| | | N. | S. | S. | | | Asia/ | | Asia/ | |
|---|---|---|---|---|---|---|---|---|---|---|
| | Eur. | Amer. | Amer. 1 | Amer. 2 | Japan | Africa | Oceania 1 | S. Kor. | Oceania 2 | Austr. |
| Europe | — | 6 | 9 | 12 | 11 | 3 | 4 | 11 | 4 | 14 |
| N. America | — | — | | | | | | | | |
| S. America 1 | — | — | — | | | | | | | |
| S. America 2 | — | — | — | — | | | | | | |
| Japan | — | — | — | — | — | | | | | |
| Africa | — | — | — | — | — | — | | | | |
| Asia/Oceania 1 | — | — | — | — | — | — | — | | | |
| South Korea | — | — | — | — | — | — | — | — | | |
| Asia/Oceania 2 | — | — | — | — | — | — | — | — | — | |
| Australia | — | — | — | — | — | — | — | — | — | — |

It is possible to estimate the memory size needed for a database such as Table 2. If there are X areas defined and it is assumed that four bits are needed for each cell in the flight time matrix (i.e., no flight times are longer than 15 hours), then the total size is given by the following equation:

NumberOfBytes=0.25(X²−X)

In Table 2, ten areas are defined, and thus the number of 8-bit bytes needed to store Table 2 is only about twenty-three.

It can be seen from the exemplary flight time matrix of Table 2 that the shortest flight time from Europe to North America is six hours, and the shortest flight time from Europe to Japan is more than six hours. Thus, if a UE had service in Europe and has been out-of-service (e.g., has been powered off) for less than six hours, the UE can determine its possible location(s) from the elapsed time and the flight time matrix, and can determine from the possible location(s) and the frequency allocation list that it has a low probability of finding service in the GSM 850, GSM 1900, WCDMA 800, WCDMA 850, and WCDMA 1900 bands. The UE can then avoid those bands in cell searching to reduce its power consumption and the time it takes to regain service.

As a complement to the frequency allocation list of Table 1, it is currently believed beneficial to store a sorted list of MCCs with information about the frequencies that are used within each MCC (i.e., within the corresponding country). This is called the “MCC list” in this application. In an advantageous embodiment, the MCC list contains the MCC as a key and is for example a bit map indicating the bands supported by the MCC. Only the frequency bands that the UE supports need to be represented in the MCC list. Table 3 is an example of the information in an MCC list.

TABLE 3

| MCC | Country | GSM | WCDMA |
|---|---|---|---|
| 202 | Greece | 900/1800 | 2100 |
| . . . | | | |
| 295 | Liechtenstein | 900/1800 | — |
| 302 | Canada | 850/1900 | — |
| . . . | | | |
| 376 | Turks and Caicos | 850 | — |
| | Islands | | |
| 400 | Azerbaijani Republic | 900/1800 | — |
| . . . | | | |
| 472 | Maldives | 900 | 2100 |
| 502 | Malaysia | 900/1800 | 2100 |
| . . . | | | |
| 552 | Palau | 900 | — |
| 602 | Egypt | 900 | — |
| . . . | | | |
| 657 | Eritrea | 900 | — |
| 702 | Belize | 1900 | — |
| . . . | | | |
| 748 | Uruguay | 850/1800/1900 | — |

It will be seen that Table 3 is a sorted list that can contain all MCCs in the world and their corresponding frequency-band allocations. The exemplary Table 3 shows allocations for GSM and WCDMA cellular access, but it will be understood that additional or other sets and arrangements of information can be used. Different UEs can have different arrangements of such information, e.g., for different RATs supported by the UEs.

If a UE supports eight bands for GSM and WCDMA, the size in 8-bit bytes of a sorted list such as Table 3, when implemented as a bit map, can be determined. Because there are about 230 MCCs defined in the world today, information corresponding to that number can easily be coded in a 16-bit (2-byte) variable, such as a bitmap. Thus, the total size of Table 3 currently would be about 700 bytes, corresponding to two bytes to encode the MCC and one byte to encode the band allocation for each of the MCCs.

It will be understood that Table 3 can be seen as a special case of Table 1, in which each geographic area is represented by one MCC. Nevertheless, it is currently believed that it is not preferable that one area would equal one MCC because it would make the flight time matrix larger, more difficult to create and maintain, and more difficult to use in search algorithms.

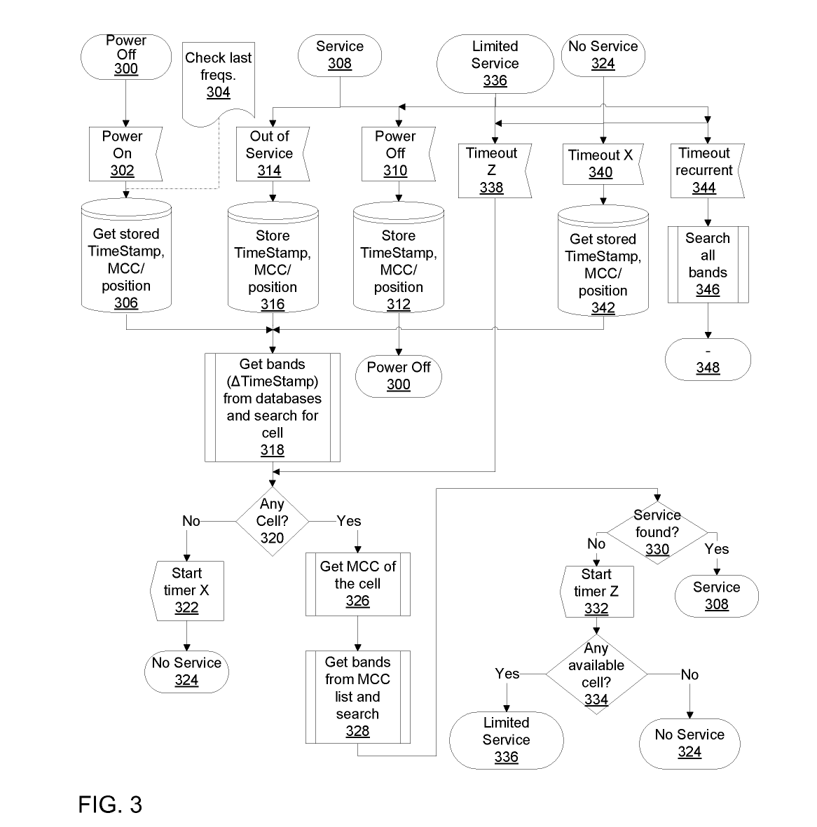

FIG. 3 is a flow chart of a method, carried out by a UE, of determining a frequency band in which to search for cell(s) based on information about a UE's current location and the time that has elapsed since service was previously obtained. The information in the frequency allocation list, the flight time matrix, and the MCC list described above is advantageously used in carrying out the method. For convenience, the chart is structured around four possible states of the UE: “Power Off”, which occurs when the UE is powered off; “Service”, which occurs when the UE has a relation with a network and is able to use all network services permitted to the UE, such as originating/terminating speech calls, etc., in a cell; “Limited Service”, which occurs when the UE can perform less than all network services permitted to the UE, such as making emergency calls; and “No Service”, which occurs when the UE has no possibility of performing any services with the network because there is no cell available or the UE is not allowed to access the cell (e.g., the cell is a barred WCDMA cell). It will be appreciated that other arrangements of states are possible without departing from the principles of this invention.

In FIG. 3, after changing from the Power-Off state 300 after a power-on indication 302, the UE typically checks one or more of the carrier frequencies on which the UE most recently had service (indicated by block 304). Identifiers of those last carrier frequencies are typically stored by the UE before the UE completely powers off.

If no cell is found on the stored last frequencies, e.g., the power level of the received signal is insufficient, the UE retrieves (step 306) a stored time indicator and a stored location indicator which indicate the time and location at which the UE last had service. Those data items can be stored as the result of method steps described in more detail below, and as described above, the position indicator can be an MCC, geographic coordinates that can be determined by a GPS device, or similar information.

From the Service state 308, the UE can be powered off after a power-off indication (step 310), which involves storing Power-Off data, including the carrier frequency on which the UE has service, and storing the current time, e.g., by a suitable time stamp, and the current position indicator (step 312).

From the Service state 308, the UE may also lose service, e.g., by moving into an area that blocks radio reception. When the UE detects such an out-of-service condition (step 314), the UE stores information that is substantially similar to the Power-Off data, including the current time and position (step 316).

After retrieving the stored time stamp and position indicator (e.g., step 306), the UE determines which frequency band or bands are unlikely to yield a successful cell search as described above and searches for a cell in the remaining band(s) (step 318). Of course it will be understood that the UE equivalently can determine which frequency band or bands are more likely, relative to other frequency bands, to yield a successful cell search and then search for a cell in those band(s).

If no cell is found (No in step 320), the UE starts a settable timer X (step 322) and enters the No-Service state 324. The X timer is described in more detail below and may be a software timer rather than a hardware timer.

If a cell is found (Yes in step 320), the UE obtains the MCC of that cell (step 326), and retrieves the corresponding frequency bands from the MCC list and searches, based on the retrieved information, for a possibly better cell that yields full network services (step 328). If service is found as a result of the cell search (Yes in step 330), the UE enters the Service state 308. If full service is not found (No in step 330), the UE starts a settable timer Z (step 332), which is described in more detail below and may be a software timer rather than a hardware timer, and determines whether there is any available cell (step 334) after the search is performed (step 328). This deals with the possibility that a cell found in step 326 might be lost while the UE searches the band(s) in step 328. If an available cell is not found (No in step 334), the UE enters the No-Service state 324. If an available cell is found (Yes in step 334), the UE enters the Limited-Service state 336.

As depicted by FIG. 3, the Z timer controls how often the UE searches for a cell that enables the UE to leave the Limited-Service State 336 or the No-Service state 324. When the UE determines that the Z timer has timed out (step 338), the UE carries out steps 320 etc. as described above.

The X timer controls how often the UE searches for a cell that enables the UE to leave the No-Service state 324. When the UE determines that the X timer has timed out (step 340), the UE retrieves (step 342) a stored time indicator and a stored location indicator which indicate the time and location at which the UE last had service, as in step 306, and carries out steps 318 etc. as described above.

A recurrent timer is also advantageously provided that controls how often the UE searches all frequency bands supported by the UE without using the stored time stamp and position information in an effort to leave the Limited-Service and No-Service states 336, 324. If provided, such a recurrent timer helps reduce the chances that the stored information “misleads” the UE in its search for a cell because the databases may not be completely accurate. Inaccuracy can arise in the databases in several ways, e.g., new frequency bands can be introduced in different parts of the world before the UE's databases are updated. Methods of updating the databases are described in more detail below. The recurrent timer is advantageously started when the UE leaves the service state and is continually re-started while the UE does not have service.

When the UE determines that the recurrent timer has timed out (step 344), i.e., when the UE leaves the Limited-Service state or the No-Service state, the UE carries out the cell search procedure specified by the 3GPP specifications without relying on the stored time and position information (step 346). As the result of such procedure, the UE enters one of the Service, Limited-Service, and No-Service states 308, 336, 324 (indicated by the terminator block 348), after which the method continues from the particular state as described above.

Of course, the Service state 308 is the desired state when the UE is powered on. In the Limited-Service state 336, the UE knows at least one cell and the MCC can be read from that cell. If the No-Service state 324 is the result of not being allowed to access a cell, the MCC can be read from that cell.

FIG. 3 shows a method of searching the different frequency bands that a UE is able to operate in when the UE is in the Limited-Service and No-Service states 336, 324. The different databases described above together with the time elapsed since the UE last had service are used to reduce the search time and effort spent by the UE on frequency bands in which it is not probable that the UE will find service.

It should be noted that the timer values in FIG. 3 (i.e., X, Z, and recurrent) do not need to be the same all the time. Instead, they can for example be increased as time goes by when service cannot be obtained. The recurrent timer can be set for example based on input from the flight time matrix and the time the UE has been out-of-service. The timer values are typically low in the beginning just after the out-of-service is detected and are increased as time goes if no service can be obtained. It is currently believed that the timer values can start out of the order of seconds and then gradually increase to of the order of tens of seconds or minutes. The size of a timer's maximum value generally depends on the timer type, and each timer can be controlled (increased or decreased) independently of the other timers.

It will be understood that the frequency allocation list and the flight time matrix can be seen as optional with only Table 3 stored in the UE. In such an embodiment, a threshold value together with the MCC can be used in step 318 to select the bands to search on in the following way. If the time difference between the stored time stamp and the current time, e.g., a ATimeStamp, is smaller than the threshold, only the bands from Table 3 are used; otherwise, all bands are used. It will be noted that when the process flow comes to step 318 from step 316, the ATimeStamp value will be zero, and for other cases (i.e., when a stored value is retrieved), the ATimeStamp value will be non-zero.

The databases can be updated during the lifetime of the UE in any suitable way. For example, two types of updates that can be performed are external updates and UE self-learning updates.

An external update can be done in many ways, including, as a non-exhaustive list, from the internet (compare with “Windows update”) by setting up a packet-switched connection; through an external equipment, such as a PC or another UE; through received SMS messages or another device management provisioning method; and through user interaction in the UE's man-machine interface. Common for this type of update is that an external source is used to update the databases and it is applicable to all three databases described.

The UE self-learning type of updates involves algorithms in the UE that trigger the update of the databases when certain criteria are met. This type of update typically would not be done to the flight time matrix because it is difficult to estimate flight times between areas with accuracy. On the other hand, a GPS-enabled UE can detect that it is “flying” and can use that information to update the flight time matrix. The frequency allocation list and the flight time matrix are tightly coupled and therefore it is currently believed that the defined areas should not be changed. The frequency allocation list can still be updated by expanding the supported frequency bands for an area when service has been granted on a new frequency band that the database does not include. Similarly the MCC list can be updated based on the UE's getting service on a frequency band that is not present in the list. It is currently believed that the UE should not remove any frequencies from the lists by the self-learning method because the UE cannot determine whether a frequency is present at least somewhere within the area or MCC.

A UE functioning according to the present invention will (compared to a UE with conventional cell searching algorithms) consume much less time and energy on finding the correct frequency band. This significantly improves the UE's performance in scenarios in which the UE needs to regain service after moving between geographic areas where different frequency bands are employed for communication or after being temporarily out of service (e.g., due to radio shadow, bad coverage, etc.).

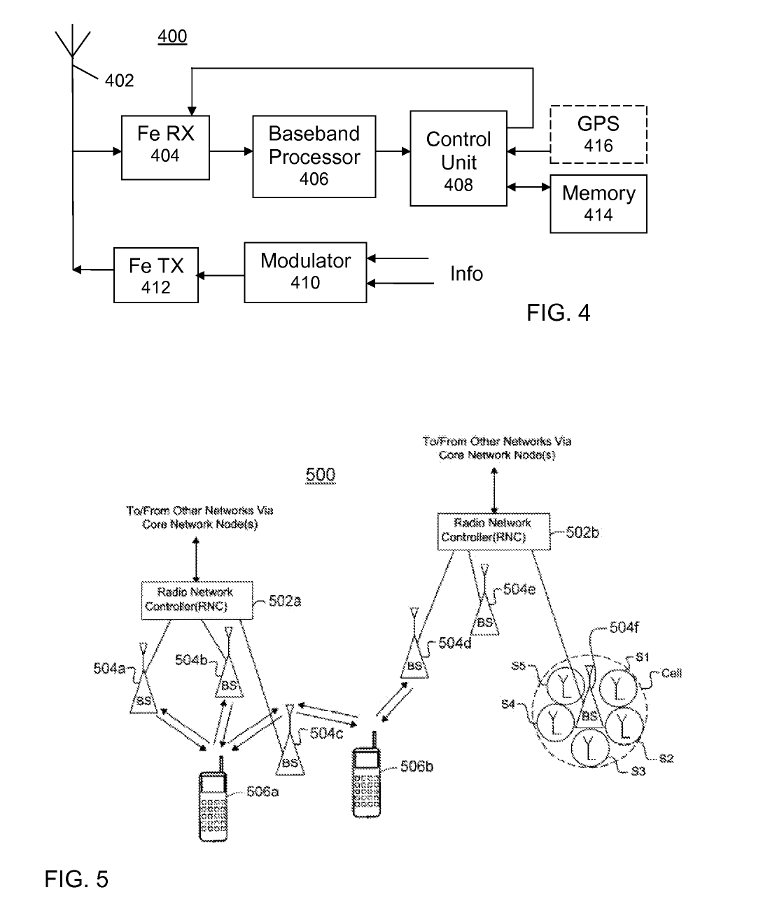

FIG. 4 is a block diagram of a portion of a UE 400 that is suitable for implementing the methods described above. For simplicity, only some parts of the UE 400 are shown in the figure. It will also be understood that the UE can be implemented by other arrangements and combinations of the functional blocks shown in FIG. 4 and can operate according to cellular communication technologies based on for example WCDMA, TDMA, orthogonal frequency division multiplex (OFDM), etc.

Signals transmitted by RBSs are received through an antenna 402 and down-converted to base-band signals by a front-end receiver (Fe RX) 404. In a WCDMA communication system, the received signal code power (RSCP) is estimated at frequencies in bands supported by the UE, which is to say that cells are detected, and the received signal strength indicator (RSSI) is computed by a baseband processor 406. A RSCP can be estimated by, for example, de-spreading the base-band signal from a possibly detected cell with the scrambling code (and common pilot channel (CPICH) channelization code) corresponding to the cell. Methods of computing RSSIs are well known in the art. In suitable communication systems, for example, the RSSI can be estimated by computing the variance of the received signal over a given time period, such as one time slot (e.g., 0.67 ms). Information from the baseband processor 406 is provided to a control unit 408, which uses the information in searching for cells (RBSs) according to the methods described above. Based on the results of such searches and other factors, the control unit 408 controls the operation of the Fe RX 404. The UE 400 also typically includes a front-end transmitter (Fe TX) 412 that up-converts or otherwise transforms a modulation signal for transmission to RBSs through the antenna 402.

The control unit 408 and other blocks of the UE 400 can be implemented by one or more suitably programmed electronic processors, collections of logic gates, etc. that process information stored in one or more memories 414. The stored information includes the information described above in connection with Tables 1-3 and lists of available and neighboring cells and most recently used frequencies and frequency bands, which the control unit 408 can use in searching for cells in accordance with the features of this invention. It will be appreciated that the control unit typically includes or implements timers, etc. that facilitate its operations and that are used in the methods described above.

As shown in FIG. 4, the control unit 408 can also optionally receive information about the current location of the UE 400, e.g., latitude and longitude, from a suitable GPS device 416. The optional nature of the GPS device 416 is indicated by the dashed lines in FIG. 4. It will be understood that the GPS device 416 is not limited to obtaining position information from the GPS constellation of satellites but can develop position information in other ways or using other technologies. For example, the GPS device 416 may be a LORAN, SAT/NAV, OMEGA, GLONASS, GALILEO, or other type of position determining unit. In this application, any device used for obtaining position information is called a GPS device for convenience.

FIG. 5 is a diagram of a PLMN 500, which may be, for example, a WCDMA communication system. Radio network controllers (RNCs) 502a, 502b control various radio network functions, including for example radio access bearer setup, diversity handover, etc. More generally, each RNC directs UE calls via the appropriate RBSs, which communicate with UEs 506a, 506b through downlink (i.e., base-to-mobile, or forward) and uplink (i.e., mobile-to-base, or reverse) channels. RNC 502a is shown coupled to RBSs 504a, 504b, 504c, and RNC 502b is shown coupled to RBSs 504d, 504e, 504f. Each RBS, which is called a Node B in 3GPP parlance, serves a geographical area that can be divided into one or more cell(s). RBS 504f is shown as having five antenna sectors S1-S5, all or some of which can be said to make up the cell of the RBS 504f. The RBSs are coupled to their corresponding RNCs by dedicated telephone lines, optical fiber links, microwave links, etc. Both RNCs 502a, 502b are typically connected with external networks such as the PSTN, the Internet, etc. through one or more core network nodes, such as an MSC and/or a packet radio service node (not shown). The artisan will understand that the components and arrangement depicted in FIG. 5 are examples and should not be construed as limiting the components and arrangement of an actual communication system.

It is expected that this invention can be implemented in a wide variety of environments, including for example mobile communication devices. It will be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Many communication devices can easily carry out the computations and determinations described here with their programmable processors and application-specific integrated circuits.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of determining a frequency band in which to search for a cell in a communication system having plural cells, wherein the method is carried out in a user equipment (UE) in the communication system, and comprises the steps of:
checking for a cell at a frequency in a frequency band, the frequency being a frequency on which the UE previously had service from the communication system;
if a cell is not found at the frequency, carrying out the steps of:
determining a current location indicator, wherein determining the current location indicator comprises:
either determining a current location based on signals transmitted in a global positioning system, or
retrieving a stored time indicator that indicates a time at which the UE previously had service and a stored location indicator that indicates a location of the UE at the time at which the UE previously had service, determining an elapsed time since the time at which the UE previously had service, and determining at least one possible location based on the elapsed time and a set of shortest flying times from the location of the UE at the time at which the UE previously had service; and
determining at least one frequency band in which to search for a cell based on the current location indicator.

2. The method of claim 1, further comprising the step of updating at least one of the set of shortest flying times and a stored set of frequency bands and respective locations either by receiving update information from the communication system or by self-learning from experience.

3. The method of claim 2, wherein the updating step includes updating a stored set of mobile country codes and respective frequencies, and updating by self-learning from experience includes altering at least one of the stored set of frequency bands and respective locations and the stored set of mobile country codes and respective frequencies based on finding a cell in a frequency band at a location that is not included in the at least one stored set.

4. The method of claim 1, wherein each of the stored and current location indicators is at least one of a mobile country code and a set of geographic coordinates.

5. The method of claim 1, further comprising the step of storing the stored time indicator and the stored location indicator.

6. The method of claim 1, further comprising the step of searching for a cell in the determined at least one frequency band.

7. The method of claim 6, wherein if a cell is not found by the searching step, initiating measuring of a first time period, determining if the first time period has elapsed, and if the first time period has elapsed, repeating the steps of determining the current location indicator and determining at least one frequency band.

8. The method of claim 6, wherein if a cell is found by the searching step, determining a mobile country code corresponding to the found cell, and determining at least one frequency band corresponding to the determined mobile country code.

9. The method of claim 8, wherein if the found cell provides limited service, initiating measuring of a second time period, determining if the second time period has elapsed, and if the second time period has elapsed, repeating the step of searching for a cell in the determined at least one frequency band.

10. An apparatus in a user equipment (UE) for determining a frequency band in which to search for a cell in a communication system having plural cells, the apparatus comprising:
a device configured to check for a cell at a frequency in a frequency band, the frequency being a frequency on which the UE previously had service from the communication system; and
a processor configured, if a cell is not found at the frequency, to determine a current location indicator either by determining a current location based on signals transmitted in a global positioning system or by retrieving a stored time indicator that indicates a time at which the UE previously had service and a stored location indicator that indicates a location of the UE at the time at which the UE previously had service, determining a current location indicator based on an elapsed time since the time at which the UE previously had service and at least one possible location based on the elapsed time and a set of shortest flying times from the location of the UE at the time at which the UE previously had service; and to determine at least one frequency band in which to search for a cell based on the current location indicator.

11. The apparatus of claim 10, wherein the processor is further configured to update at least one of the set of shortest flying times and a stored set of frequency bands and respective locations either by receiving update information from the communication system or by self-learning from experience.

12. The apparatus of claim 11, wherein the processor is further configured to update a stored set of mobile country codes and respective frequencies, and updating by self-learning from experience includes altering at least one of the stored set of frequency bands and respective locations and the stored set of mobile country codes and respective frequencies based on finding a cell in a frequency band at a location that is not included in the at least one stored set.

13. The apparatus of claim 10, wherein each of the stored and current location indicators is at least one of a mobile country code and a set of geographic coordinates.

14. The apparatus of claim 10, wherein the processor is further configured to store the stored time indicator and the stored location indicator.

15. The apparatus of claim 10, further comprising a device configured to search for a cell in the determined at least one frequency band.

16. The apparatus of claim 15, wherein if a cell is not found by a search, the processor is configured to initiate measuring of a first time period, to determine if the first time period has elapsed, and if the first time period has elapsed, to again determine the current location indicator and at least one frequency band.

17. The apparatus of claim 15, wherein if a cell is found by a search, the processor is configured to determine a mobile country code corresponding to the found cell, and to determine at least one frequency band corresponding to the determined mobile country code.

18. The apparatus of claim 17, wherein if the found cell provides limited service, the processor is configured to initiate measuring of a second time period and to determine if the second time period has elapsed, and if the second time period has elapsed, the device configured to search for a cell in the determined at least one frequency band searches again for the cell in the determined at least one frequency band.

19. A computer-readable medium having stored instructions that, when executed by a computer, cause the computer to perform a method of determining a frequency band in which to search for a cell in a communication system having plural cells, wherein the method is carried out in a user equipment (UE) in the communication system, the method comprising the steps of:
checking for a cell at a frequency in a frequency band, the frequency being a frequency on which the UE previously had service from the communication system;
if a cell is not found at the frequency, carrying out the steps of:
determining a current location indicator, wherein determining the current location indicator comprises:
either determining a current location based on signals transmitted in a global positioning system, or
retrieving a stored time indicator that indicates a time at which the UE previously had service and a stored location indicator that indicates a location of the UE at the time at which the UE previously had service, determining an elapsed time since the time at which the UE previously had service, and determining at least one possible location based on the elapsed time and a set of shortest flying times from the location of the UE at the time at which the UE previously had service; and
determining at least one frequency band in which to search for a cell based on the current location indicator.

20. The computer-readable medium of claim 19, wherein the method further comprises the step of updating at least one of the set of shortest flying times and a stored set of frequency bands and respective locations either by receiving update information from the communication system or by self-learning from experience.

21. The computer-readable medium of claim 20, wherein the updating step includes updating a stored set of mobile country codes and respective frequencies, and updating by self-learning from experience includes altering at least one of the stored set of frequency bands and respective locations and the stored set of mobile country codes and respective frequencies based on finding a cell in a frequency band at a location that is not included in the at least one stored set.

22. The computer-readable medium of claim 19, wherein the method further comprises the step of searching for a cell in the determined at least one frequency band.

23. The computer-readable medium of claim 22, wherein if a cell is not found by the searching step, the method further comprises initiating measuring of a first time period, determining if the first time period has elapsed, and if the first time period has elapsed, repeating the steps of determining the current location indicator and determining at least one frequency band.

24. The computer-readable medium of claim 22, wherein if a cell is found by the searching step, the method further comprises determining a mobile country code corresponding to the found cell, and determining at least one frequency band corresponding to the determined mobile country code.

25. The computer-readable medium of claim 24, wherein if the found cell provides limited service, the method further comprises initiating measuring of a second time period, determining if the second time period has elapsed, and if the second time period has elapsed, repeating the step of searching for a cell in the determined at least one frequency band.
